(19) United States
(12) Patent Application Publication
(10) Pub. No.: US 2006/0048795 A1
(43) Pub. Date: Mar. 9, 2006

(54) Method of executing a rinse cycle of a program-controlled dishwasher

(76) Inventors: Martin Kornberger, Bielefeld (DE); Horst Moeller, Werther (DE)

Correspondence Address: Law Offices of Karl Hormann, P.O. Box 381516, Cambridge, MA, 02238-1516, US

(21) Appl. No.: 11/218,795

(22) Filed: Sep. 3, 2005

(30) Foreign Application Priority Data
Sep. 7, 2004 (DE) 10 2004 043 657.6

(51) Int. Cl. B08B 7/04

(52) U.S. Cl. 134/18

(57) ABSTRACT

A method of operating a dishwasher selectively operable in a first program using a detergent and a predetermined quantity of rinse agent separate from each other and a second using a compound consisting of detergent and rinse agent wherein in the second program an additional quantity of rinse agent less than the predetermined quantity is provided. The predetermined and additional quantities are preferably provided from a dispenser.

### BACKGROUND OF THE INVENTION

1. Field of the Invention

The invention, in general, relates to a method of executing the rinse cycle of a program-controlled dishwasher and, more particularly, to a method of executing the rinse cycle of a dishwasher provided with operational controls for selecting at least one dishwashing program tied to the use of a conventional dishwasher detergent as well as a rinse agent provided from a dispensing device and at least one further washing program adapted to the use of a combination compound containing at least a rinse agent and a detergent.

2. The Prior Art.

Dishwashers adapted to the use of conventional dishwasher detergents as well as combination compounds are known from German patent specification DE 100 49 489 A1, DE 102 20 839 A1, DE 102 30 567 A1 and European patent specification EP 1,362,547 A2. The combination compounds are so-called “2 in 1” and “3 in 1” tablets which in addition to a detergent contain a rinse agent (“2 in 1”) or a rinse agent and regenerating salt surrogates (“3 in 1”). Some of these compounds work according to what may conveniently be called a carry-over principle, in which an excessive quantity of the rinse agent dissolves at the beginning of the washing program and in which the actually needed quantity is to be available to the dishes to be washed by migration and adhesion well into the rinse cycle. In other compounds, the rinse agent is integrated as a wax-encapsulated pearl, the wax being intended to dissolve as a function of temperature or pH value not before the rinse cycle in order to release the rinse agent. The dishwashers known from DE 100 49 489 A1, DE 102 20 839 A1 and DE 102 30 567 A1 are adjusted to the use of such compounds by means for blocking the supply of rinse agent from the dispensing device which is usually positioned in the door of the dishwasher.

In dishwashing programs in which the dishwashing fluid is at a high temperature during the washing cycle already, the mentioned compounds do not work satisfactorily because the rinse agent contained in the tablet is dissolved in the washing fluid and is discharged with the washing fluid at the termination of the washing cycle. Hence, the absence of rinse agent during the final rinse cycle results in poor drying. Another disadvantage arises if the mentioned dishwashers are operated exclusively in “2 in 1” and “3 in 1” programs over an extended period of time, as would be the case after purchase of a large package of such combination tablets. If no rinse agent is dispensed from the dispenser for an extended period of time, the actuation mechanism of the dispenser is likely to become damaged and, more particularly, any gaskets associated with it may gum up. Furthermore, any rinse agent left in the dispenser may coagulate, thicken or change to flakes.

From EP 1,362,547 A2 it is known cycle in connection with “2 in 1” or “3 in 1” programs to measure the concentration of the rinse agent at the beginning of the rinse cycle and to add rinse agent as a function of the result of the measurement. While this would lead to satisfactorily dried dishes without streaks and stains, the result is attained requires the use of an expensive sensor arrangement. In addition, the disadvantages resulting from and extended idleness of the dispensing device cannot be avoided.

### OBJECT OF THE INVENTION

It is thus an object of the invention to provide a method of executing a rinse cycle in a program-controlled dishwasher of the kind referred to supra which avoids and overcomes the mentioned drawbacks and which renders satisfactory results of drying even when using a “2 in 1” or “3 in 1” cleaning compound.

Other objects will in part be obvious and will in part appear hereinafter.

### SUMMARY OF THE INVENTION

In the accomplishment of these and other objects, the invention provides for a rinsing cycle within a dishwashing program which is adapted to the use of a combination cleaning compound containing a rinse agent in addition to the detergent and which adds a predetermined quantity of rinsing agent from a dispenser, the quantity being less than the quantity of rinse agent added from a dispenser during a rinse cycle of a dishwashing program using conventional separate detergent and rinse agent.

In an advantageous embodiment of the invention the predetermined lesser quantity is between 20% and 40% of the quantity used in a rinse cycle of a dishwashing program using a conventional detergent and a rinse agent supplied from a dispensing device. Thus, only a small yet in normal circumstances sufficient quantity of rinse agent is consumed sufficiently to supplement the quantity of rinse agent present in the combination compound.

In a method of executing a dishwashing program adapted to the use of a combination compound containing at least one rinse agent in addition to the detergent, it is particularly advantageous during the program cycle to deactivate any devices otherwise indicating the lack of rinse agent in the dispenser device. In this manner, a user can decide on his own whether he wishes improved drying results by filling the dispenser device or whether he wishes to rely solely upon the action of the combination compound. In either case, the dispensing device will be completely emptied of any rinse agent.

### DESCRIPTION OF THE PREFERRED EMBODIMENT

An embodiment of the method in accordance with the invention will be described hereinafter. A dishwasher of the kind provided with a unit for selecting “normal” dishwashing programs as well as “2 in 1” and “3 in 1” programs, is known from German patent specification DE 102 20 839 A1 the contents of which are incorporated by reference herein. For purposes of the present invention, it will, however, be sufficient to mention that the dishwasher described therein is provided with a selector switch for manually adjusting the cycles of the operational program of the machine to one of “normal”, “2 in 1” or “3 in 1” washing compounds. The cycles may, for instance, be pre-rinse, washing, intermediate rinse, final rinse, and drying, and are separated from each other by adding or changing of water or dishwashing fluid. In the “normal” setting, a small amount, for instance about 3 ml, of rinse agent is added from a dispenser positioned in the door of the dishwasher to the rinse water in the dishwasher chamber during the final rinse. For “2 in 1” or “3 in 1” operation, the process parameters of individual program cycles are modified relative to those of the “normal” program by adjustment to the use of a particular combination compound. Whereas in the prior art dishwasher the rinse agent dispenser remains closed during the final rinse cycle of either “2 in 1” or “3 in 1” program, the dispenser, in accordance with the invention is activated to add 1 ml of rinse agent to the water during the final rinse cycle, but in a particularly advantageous embodiment of the invention, any display which in the “normal” program would indicate the absence of rinse agent is deactivated in order not to confuse the user.

What is claimed is:

1. A method of executing the rinse cycle of a dishwasher selectively operable in a first program using a detergent and, separate therefrom, a predetermined quantity of rinse agent provided from a dispenser and a second program using a compound consisting of detergent and a rinse agent, comprising the step:
when operating in the second program of providing from the dispenser an additional quantity of rinse agent less than the predetermined quantity.

2. The method of claim 1, wherein the additional quantity is between 20% and 40% of the predetermined quantity.

3. The method of claim 2, wherein the predetermined quantity is about 3 ml and the additional quantity is about 1 ml.

4. The method of claim 1, wherein the dishwasher is provided with a display for indicating the absence of rinse agent in the dispenser, comprising the further step of deactivating the display during operation of the dishwasher in the second program.
